(19) United States
(12) Patent Application Publication
(10) Pub. No.: US 2010/0012333 A1
(43) Pub. Date: Jan. 21, 2010

(54) PUMP MODULE CONTROL SYSTEM HAVING A SERIAL LINK

(75) Inventors: John C. Fisher, Tampa, FL (US); Erik Lukas, Gainesville, FL (US); James Kloss, Gainesville, FL (US)

Correspondence Address: PATTON BOGGS LLP, 8484 WESTPARK DRIVE, SUITE 900, MCLEAN, VA, 22102, US

(73) Assignee: Federal Signal Corporation, Oak Brook, IL (US)

(21) Appl. No.: 12/173,479

(22) Filed: Jul. 15, 2008

(51) Int. Cl. A62C 27/00; F16K 31/02

(52) U.S. Cl. 169/24; 251/129.04

(57) ABSTRACT

A control system for a pumping system in a pumping vehicle is disclosed. The control system includes a valve controller unit having an addressable communication module configured to exchange control and status data regarding a pump valve with at least one valve interface unit. The control system also includes a valve interface unit having an addressable communication module configured to exchange control and status data regarding a pump valve with at least one valve controller unit. The control system further includes a serial communication link communicatively connecting the valve interface unit and the valve controller unit.

### TECHNICAL FIELD

The present disclosure relates to pump control systems used in pumping systems. More particularly, the present disclosure relates to a pump control system using a serial link.

### BACKGROUND

Pumping systems, such as systems found on fire apparatus, are used to route water, foam, and possibly other liquids for output in fighting fires. These liquids are generally stored in one or more reservoirs on the pumping systems. These pumping systems generally include a valve system including large number of valves that control access to the reservoirs of liquid and foam. The valve system resides at the rear portion of the vehicle, in proximity to the reservoir of liquid and/or foam.

Fire apparatus generally include control panels in close proximity to the set of valves on the fire apparatus. The control panel includes a number of control systems, such as buttons and switches that connect to valve interfaces that control opening and closing of valves to direct output of fluids from the reservoir on the fire apparatus. The control panel also generally includes a number of gauges indicating the status (e.g. pressure and volume) of the valves.

An example “prior art” pumping system 100 is shown in FIG. 1. In that pumping system, a number of valve systems 102_{1-N} connect between a pump panel 104 and a pump module 106. There are typically a large number of valve systems on each pumping system of a fire apparatus. Each of the valve systems 102_{1-N} connects a set of valves in the pump module 106 to a set of switches 108 on the pump panel 104 via a direct wired connection. The switches 108 control actuation of the valves, which can include a water valve 109 and a foam valve 110 as shown. A sensor in the pump module 106, shown as a pressure sensor 112, connects to a pressure gauge 114 in the pump panel 104. Due to the direct wired connection, each valve has a dedicated switch on the pump panel 104.

Systems using the various valves and sensors in the pumping system 100 generally require the control panel to be placed in close proximity to the valve systems on a fire apparatus. This is because each of the controls (switches and buttons) and gauges on the pump panel 104 is typically connected to its corresponding valve or sensor via a direct wired connection. Direct connection to each of the valves 109, 110 and sensors 112 on the pump module 106 results in a large number of wired connections to the pump panel 104. Additionally, the direct wired system requires heavy gauge wire to be used to ensure that the wire can carry the necessary current to drive valve motors associated with the valves 109, 110.

Placing the pump panel in close proximity to the valves can have disadvantages as compared to other possible arrangements. For example, it can be preferable to place the pump panel 104 within the cab of the fire apparatus to allow the driver of the fire apparatus to also control the pumping systems. Further, placing the pump panel 104 within the cab can protect the operator of the pump panel from environmental conditions (e.g. smoke or weather conditions). However, as the distance between the pump panel 104 and the valves of the pump module 106 increases, each of the wired connections is required to be extended, resulting in a large number of extended wires. This increases the cost and complexity of wiring the pump panel 104 to the pump module 106.

For these and other reasons, improvements are desirable.

### SUMMARY

In accordance with the following disclosure, the above and other problems are solved by the following:

In a first aspect, a control system for a pumping system in a pumping vehicle is disclosed. The control system includes a valve controller unit having an addressable communication module configured to exchange control and status data regarding a pump valve with at least one valve interface unit. The control system also includes a valve interface unit having an addressable communication module configured to exchange control and status data regarding a pump valve with at least one valve controller unit. The control system further includes a serial communication link communicatively connecting the valve interface unit and the valve controller unit.

In a second aspect, a method of communicating pump controls between a valve control unit and a valve interface unit is disclosed. The method includes transmitting a pump valve command over a serial link from a valve control unit, and receiving the pump valve command at the valve interface unit.

In a third aspect, a fire apparatus is disclosed. The fire apparatus includes a pumping system including a plurality of pump valves and a control system for the pumping system. The control system includes a valve controller including an addressable communication module configured to exchange control and status data regarding at least one of the plurality of pump valves with at least one valve interface. The control system also includes a valve interface associated with at least one of the plurality of valves, the valve interface including an addressable communication module configured to exchange control and status data regarding the at least one pump valve with the valve controller. The control system further includes a serial communication link communicatively connecting the valve interface and the valve controller.

### BRIEF DESCRIPTION OF THE DRAWINGS

FIG. 1 illustrates a schematic view of a prior art arrangement of a plurality of valve systems in a pumping system;

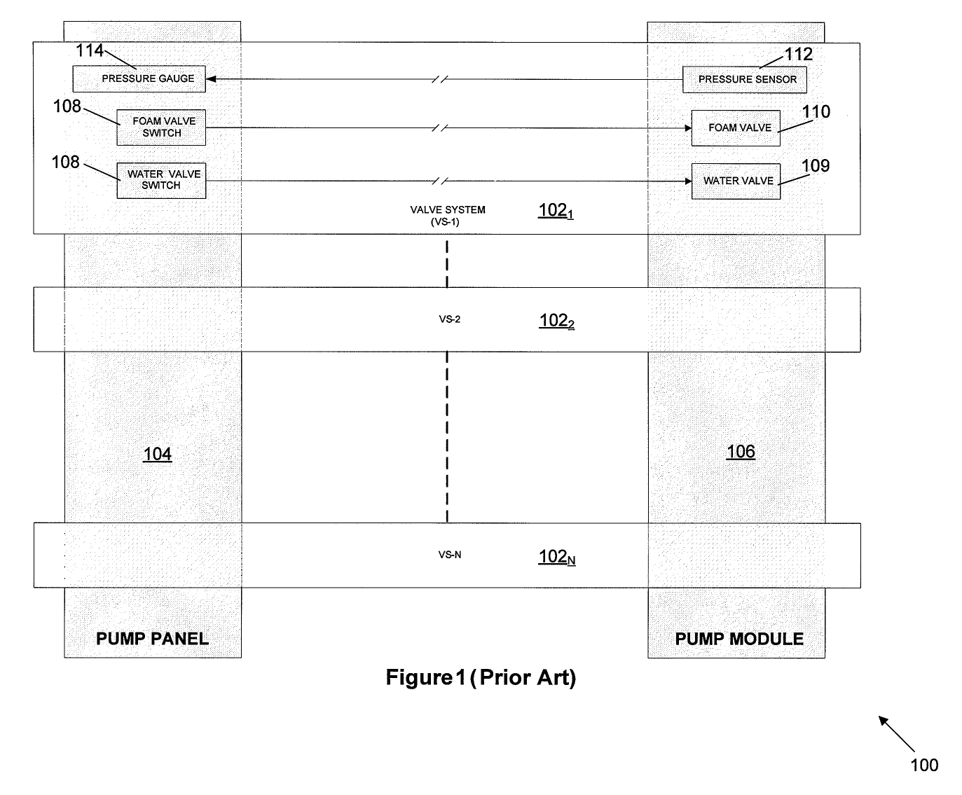

FIG. 2 illustrates a flowchart of methods and systems for communicating pump controls between a valve control unit and a valve interface unit in a pumping system, according to a possible embodiment of the present disclosure;

FIG. 3 illustrates a network in which aspects of the present disclosure can be implemented, according to a possible embodiment of the present disclosure;

FIG. 4 illustrates an embodiment of the network of FIG. 3 implemented using a remotely located pump control system;

FIG. 5 illustrates various details of the network described in FIG. 4;

FIG. 6 illustrates a further possible embodiment of the network of FIG. 3 implemented using a serial link in a pumping vehicle;

FIG. 7 illustrates an example embodiment of the network of FIG. 6 implementing a controller area network;

FIG. 8 illustrates an example valve control system useable in the systems of FIGS. 3-7;

FIG. 9 illustrates a network including a plurality of valve control systems as described in FIG. 8;

FIG. 10 is a schematic perspective cutaway view illustrating usage of a control panel of a fire apparatus, according to a possible embodiment of the present disclosure; and

FIG. 11 is a schematic side cutaway view of the fire apparatus of FIG. 10.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The present disclosure relates generally to a control system for a pumping system of a pumping vehicle, such as a fire apparatus. The control system generally includes valve control units and valve interface units. The valve control units, which can reside on a pump panel, communicatively connect to the valve interface units, and can directly address those valve interface units. The valve interface units communicate with the valve control units, and control operation of valves of a pumping system. The control system is extensible, in that one or more valve control units can interconnect with one or more valve interface units, while allowing independent addressability of each unit within the control system and simultaneously limiting the number of wired connections between the valve control units and the valve interface units.

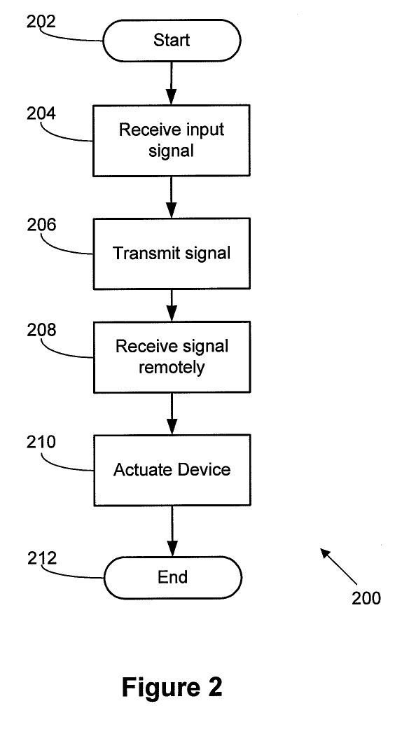

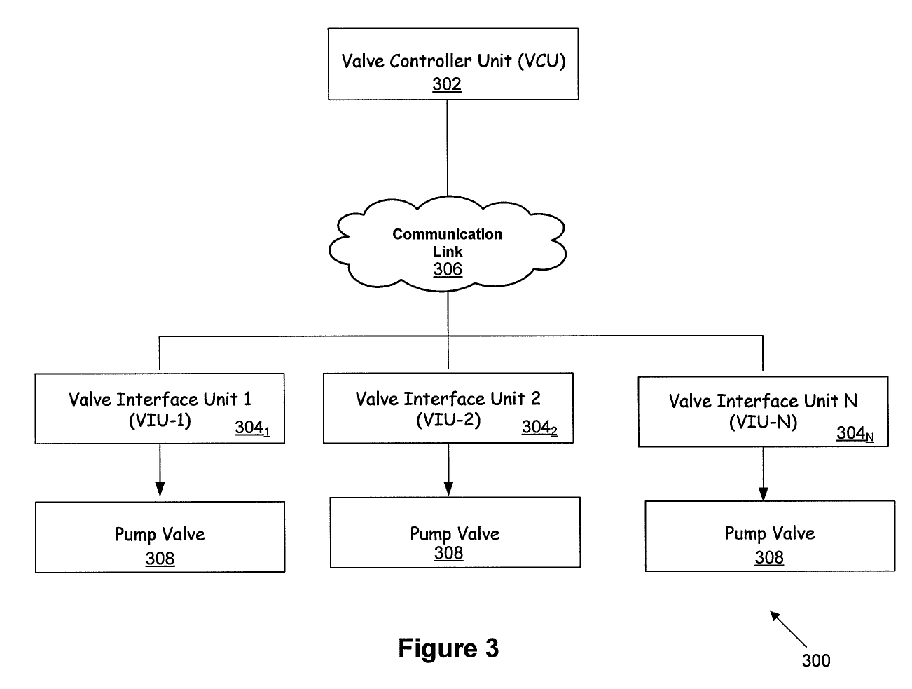

Now referring to FIG. 2, a flowchart of methods and systems 200 for communicating pump controls between a valve control unit and a valve interface unit in a pumping system is disclosed. The methods and systems 200 generally provide a process by which data can be communicated between a pump panel and a pump module to control actions of the pump module. In certain embodiments, one or both of the pump panel or the pump module can reside on a fire apparatus or other pumping vehicle. In the various embodiments described herein, the methods and systems 200 generally transmit valve control commands from a pump panel to a pump module to actuate the valves connected to that pump module. Concurrently, monitoring signals are transmitted from the pump module (e.g. relating to pressure) to the pump panel for display to an operator on a gauge or other display. Additional details regarding environments in which the methods and systems 200 are implemented are described below in conjunction with FIGS. 3-11.

Operational flow is instantiated at a start operation 202. A receive signal module 204 corresponds to receiving a signal in a control system for a pumping system.

The receive signal module 204 corresponds to receipt of a signal at either a pump panel or a pump module. In the case where the receive signal module 204 receives a signal at the pump panel, the signal can correspond to a detected change in state of a switch or button, as depressed by an operator of the control system who uses the pump panel to control operation of one or more pump modules of a pumping system. Example signals in this case correspond to requests to actuate a valve (e.g. opening or closing the valve) for a water valve or a foam valve, or commands to set a valve at a preset position.

In a second case, where the receive signal module 204 receives a signal at the pump module, the signal can correspond to a detected condition of one or more valves, such as a signal received from a pressure sensor, or a status indicator reporting the current valve position of a valve. Other sensors and corresponding signals can be incorporated into a pump module and received by the receive signal module 204 as well.

A transmit module 206 transmits data in the control system between the pump panel and the pump module from the component receiving the signal via the receive signal module 204. In various embodiments, this can correspond to transmission of data from the pump panel to the pump module, or vice versa. Data transmitted from the pump panel to the pump module can include a valve control command, which dictates an action to take with respect to one or more valves actuated by the pump module, or a valve preset command indicating a state to set a valve. Data transmitted from the pump module to the pump panel can include valve status information, such as related to the pressure or current valve position at one or more valves at the pump module.

The transmit module 206 transmits data in the control system across a communication link between the pump module and the pump panel. The communication link can take a number of forms. In certain embodiments, the communication link is a serial link connecting a pump panel (or more than one pump panel) to a pump module (or more than one pump module), allowing each pump panel or pump module to be specifically addressed by other pump panels or pump modules connected via the serial link. In such embodiments, the transmit module 206 forms a data packet to be transmitted on the serial link that includes the data relating to the pump panel or pump module, as well as an address of a destination pump panel or module. The data packet is then transmitted on the serial link for reception by the panel or module having the address incorporated in the packet. The communication link can be, for example, a packet based system using IP-addressing or other addressing techniques.

In further embodiments, the communication link can be other types of links, such as a parallel communication link or a wireless communication link. In such embodiments, the pump panel can be located remotely from the fire apparatus or other pumping system on which the pump module is located. In these further embodiments, the communication link can also be a packet based system using IP-addressing.

A receive module 208 receives, at the addressed pump panel or pump module, the communicated data transmitted by the transmit module 206. The receive module 208 determines whether the pump panel or module receiving the data is the device to which the data is addressed. If the device receiving the data is not identified by address in the received data, the device can either pass the data on to other devices (e.g. in the case where pump modules or pump panels are connected in series) or can ignore the data (e.g. in the case where data is simultaneously broadcast to all connected devices, such as in a parallel or broadcast connection).

An actuate device module 210 actuates a device associated with the pump panel or pump module addressed by the data packet and receiving the data packet via the receive module 208. In embodiments where a pump panel receives data via the receive module 208, the actuate device module 210 can correspond to updating a display on the pump panel, such as a display relating to pressure of one or more valves associated with a pump module that transmitted the data. In embodiments where a pump module receives data via the receive module, the actuate device module 210 can correspond to a pump valve command causing one or more water or foam valves to actuate, by opening, closing, or adjusting flow rate of the valves. Other actuations are possible as well. Operational flow terminates at an end operation 212.

Operation within the methods and systems 200 are best illustrated by a variety of examples of execution within a control system for a pumping system of a fire apparatus. In a first example, the methods and systems 200 operate to receive a pump valve command from a pump panel to a pump module to direct operation of the pump module. In this example, the receive signal module 204 receives an input signal from a user at the pump panel. This input signal can be converted to a data packet, including information relating to the action to be taken at the pump module (e.g. opening or closing a valve). The transmit module 206 transforms the received signal into a data packet, including data relating to the action to be taken as well as an address of the pump module at which the action is to take place (in this case forming a pump valve command). The receive module 208 operates at the pump module to determine that the pump module is the module identified in the packet and to receive the pump valve command. The actuate device module 210 opens or closes the valve in accordance with the pump valve command.

In a second example, the methods and systems operate to transmit status information relating to a pump back to the pump panel for display to a user. In this example, the receive signal module 204 receives an input signal from a sensor or other input device at a pump module (e.g. at a valve of a pumping system). This input signal can be converted to a data packet, including information relating to the sensed condition (e.g. a pressure at one or more pump valves). The transmit module 206 transforms the received signal into a data packet, including data relating to the sensed condition as well as an address of the pump panel to which the information is to be relayed. The receive module 208 operates at the pump panel to determine that the pump panel is the device identified in the packet and to receive the status information. The actuate device module 210 updates a display on the pump panel, notifying a user of the sensed condition of the valve.

Now referring to FIG. 3, a network 300 is shown in which aspects of the present disclosure can be implemented. The network 300 acts as a control system for a plurality of valves of a pumping system, such as can be found on a pumping vehicle (e.g. a fire apparatus). The network 300 includes a valve controller unit 302 and a plurality of valve interface units 304_{1-N}. The valve controller is communicatively connected to the valve interface units by a communication link 306.

The valve controller unit 302 can reside in a pump panel of a control system, and includes a variety of control mechanisms (e.g. switches and buttons, displays, gauges, and other elements) for addressing and sending valve control commands to the various valve interface units 304_{1-N}. The valve controller unit 302 also includes programmable circuitry that provides an interface to the valves and sensors of the various valve interface units, and drives operation of the various switches and gauges of the pump panel. Although only a single valve controller unit 302 is shown in the network 300, additional valve controller units can be incorporated into the network 300, each of which can independently address any of the valve interface units 304_{1-N}.

The valve interface units 304_{1-N} each include a plurality of valves and sensors, as well as an interface that can be independently addressed from each of the other valve interface units. Each of the valve interface units also can communicate with the valve controller unit. Each valve interface unit 304_{1-N} is associated with a corresponding one or more pump valves 308.

The communication link 306 provides a communicative connection between the valve controller unit 302 and the valve interface units 304_{1-N}. The communication link 306 can take a number of forms. In one embodiment, the communication link 306 is a serial link carrying digital data between the valve interface units 304_{1-N} and the valve control unit 302 of the network 300. The serial link can use differential pair transmission techniques, or can include a reference voltage wire.

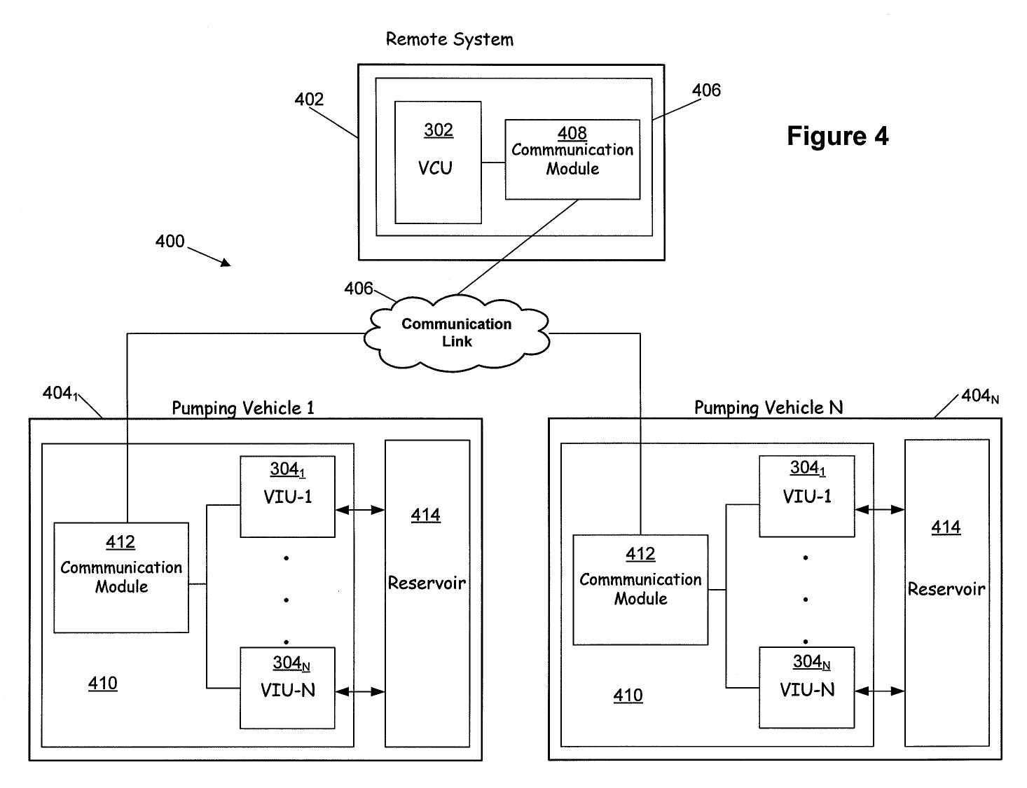

In other embodiments, the communication link 306 includes a wireless link connecting the valve control unit 302 with the valve interface units 304_{1-N}. In such embodiments, the communication link can extend among a plurality of pumping systems (e.g. fire apparatus) to a pump panel and associated valve controller units 302 which are not incorporated onto the same pumping system as the valve interface units 304_{1-N} it directs. For example, the communication link 306 could connect among a plurality of fire apparatus, and the valve control unit 302 resides on one of the fire apparatus and directs operation of valve interface units 304_{1-N} on a plurality of the fire apparatus. Or, the valve control unit 302 is external to but in proximity to all of the fire apparatus. In certain of these embodiments, one or more valve control units and valve interface units can be added to or removed from the network 300 on an ad-hoc basis according to the particular units located within communication range of each other. An example of such a configuration using a wireless communication link is shown in FIG. 4.

In certain embodiments, the various components of the network 300 form a controller area network, in which addresses are assigned and communication protocols are established according to established protocols used in other automotive systems. In certain embodiments of the communication link 306 that include a wireless link, the wireless link connects into the controller area network within one or more fire apparatus. The wireless link can be used in conjunction with an addressable module used to relay data among the valve interface units 304_{1-N} of a fire apparatus and an external pump panel containing one or more valve control units 302. An example of such a configuration is shown in FIG. 4, described below.

FIG. 4 illustrates a network 400 that uses a wireless communication link 406 to establish communication between components of a remotely located pump control system. The network 400 generally corresponds to the network 300 of FIG. 3, but illustrates specific locations and associations of components that can be used in conjunction with the wireless communication link 406.

In the network 400 shown, a remote system 402 is used in conjunction with a plurality of pumping vehicles 404_{1-N}, such as a fire apparatus. The remote system 402 contains a pump panel 406, which houses the valve control unit 302. The remote system 402 represents a portable control station, such as could be incorporated onto a fire apparatus or other type of vehicle. The pump panel 406 includes a communication module 408 that interconnects to the valve control unit 302, and provides wireless communication capabilities to the pump panel 406.

In certain embodiments, additional valve control units 302 can be incorporated into the pump panel 406. In such embodiments, the communication module 408 can be used by each of the valve control units 302 to wirelessly communicate with valve interface units 304_{1-N} of the pumping vehicles. In other embodiments, each of the valve control units 302 can be associated or include a separate communication module 408.

Each of the pumping vehicles 404_{1-N} includes a pump module 410 that includes a communication module 412 interconnected with the plurality of valve interface units 304_{1-N}. The communication module 412 is configured to wirelessly interconnect with other communication modules 406, 412 of the pump panel 404 and other pumping vehicles 404 via the communication link 306. The communication module 412 interconnects to the plurality of valve interface units 304_{1-N} that are part of the same pump module 410 via a wired link, such as a serial link implementing a controller area network protocol. Each of the valve interface units 304_{1-N} can be actuated to selectively control access to and flow of water and/or foam from a reservoir 414 associated with each pumping vehicle 404.

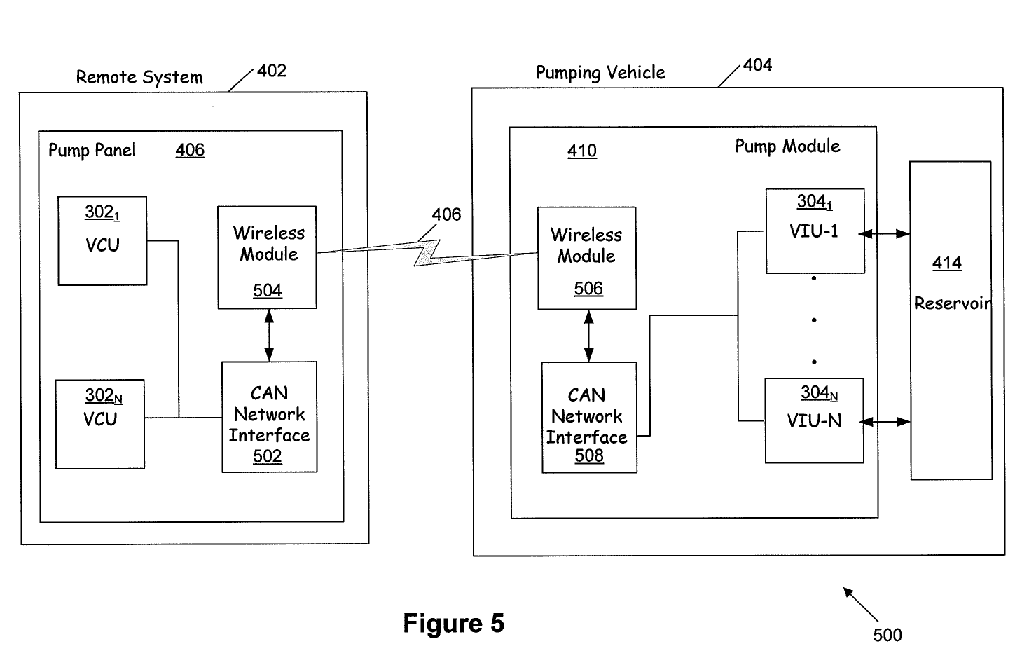

FIG. 5 illustrates various details of a sub-network 500 illustrating a portion of the network 400 described in FIG. 4. The sub-network 500 illustrates the communicative connection between the remote system 402 and a pumping vehicle 404. As illustrated, a pump panel 406 on the remote system includes a plurality of valve control units 302_{1-N} connected to a network interface component 502, which in turn is communicatively connected to a wireless module 504. The network interface component 502 is wired to the valve control units 302_{1-N} by a controller area network, corresponding to a serial bus link. The network interface component 502 acts as a bridge, receiving data received by the wireless module 504 to transmit to one of the valve control units 302_{1-N} and also transmits valve operation commands from the valve control units 302_{1-N} to the wireless module 504 for wireless transmission via the communication link 306.

The pumping vehicle 404 includes at least one pump module 410, which contains a wireless module 506 and network interface component 508. The wireless module 506 of the pumping vehicle 404 wirelessly communicates with the wireless module 504 of the remote system 402. The network interface component 508 acts analogously to the network interface component 502, receiving data from the wireless module 506 and distributing it on the serial bus connecting to the valve interface units 304_{1-N}.

Referring now to FIGS. 4-5 generally, when in use, the remote system 402 and pumping vehicles 404_{1-N} are deployed to a site where use is required, such as at the site of a fire in the case of fire apparatus. An operator associated with the remote system 402 can control operation of the various pump modules 410 on the pumping vehicles 404_{1-N} through use of the pump panel 406. The operator views a display on the pump panel 406 relating to the status of valves controlled by the pump panel, and can choose to alter the status of a valve by pressing a button or switch on the panel. The switch, incorporated into one of the valve control units 302, transmits a signal (e.g. a pump valve command) on a serial link to a network interface component 502, which transmits that signal to the wireless module 504. The wireless module 504 transmits the signal from the remote system 402 to the pumping vehicle 404, to be received at the pump module 410 in the wireless module 506. The signal is transferred to the network interface component 508 for transmission onto a serial bus, where it is detected by an appropriate valve interface unit 304 (i.e. the interface unit to which it is addressed). The valve interface unit 304 actuates a valve in accordance with the signal.

Concurrently, the valve interface unit 304 can include a sensor for detecting pressure or other characteristics of a valve. A signal is detected by the sensor and transmitted by the valve interface unit 304 back through the network interface component 508, wireless module 506, wireless module 504, network interface component 502, and to an addressed valve control unit 302 for display to a user (e.g. for updating a display, a gauge, or other visual indicator).

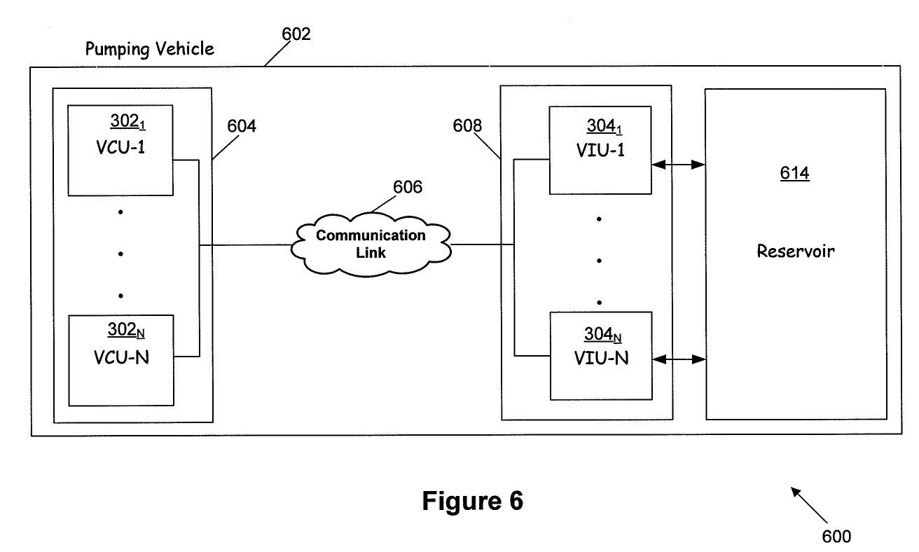

FIG. 6 illustrates a control system 600 implemented using a communication link within a pumping vehicle. The control system 600 generally corresponds to an embodiment of the network 300 of FIG. 3 when located in a single pumping vehicle 602, such as a fire apparatus.

In the embodiment shown, a pump panel 604 includes a plurality of valve control units 302_{1-N} which connect via the communication link (illustrated as serial link 606) to a corresponding plurality of valve interface units 304_{1-N} in a pump module 608. In this case, because the communication link 306 corresponds to a serial link 606, the network interface components and wireless modules described in FIG. 5 are absent. However, these components could be incorporated into the pump panel and pump module if so desired to allow a possibility for remote control of the valve control units of the pumping vehicle 602.

In the control system 600 shown, the communications among modules is generally wired; therefore, the components generally reside within a single pumping vehicle 602. However, due to use of a low-wire count serial link 606, the pump panel 604 can include a large number of valve control units while located remotely from the pump module 608 and the valve interface units without requiring a large number of wires connected therebetween.

The specific type of serial link or communication link used in the control system 600 can vary, according to different embodiments of the present disclosure. For example, in certain embodiments, the serial link can be an RS-232 or other wired serial link. In other embodiments, other types of serial data streams (e.g. fiberoptic, wired, or wireless) can be used.

In a possible embodiment of the control system 600, the pump panel 604 is located in a cab portion of the pumping vehicle, whole the pump module 608 resides toward a rear portion of the pumping vehicle, near a reservoir 614 of water, foam, or other liquid.

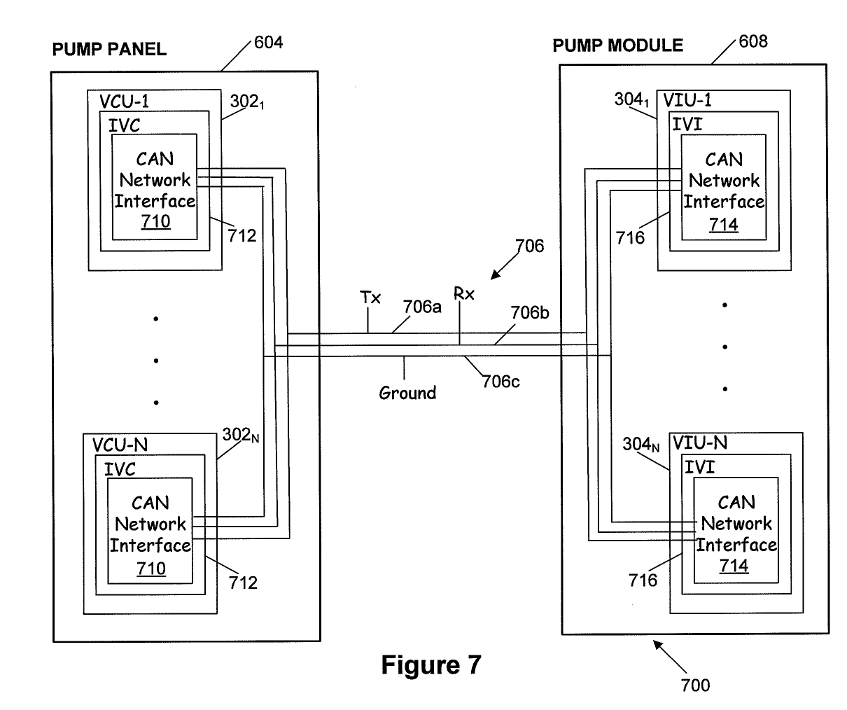

FIG. 7 illustrates one possible embodiment of the control system 700 used in the network 600. In the control system 700, the serial link 606 of FIG. 6 can be implemented using one possible controller area network connection 706. The controller area network connection 706 as shown is a three-wire connection, including a transmit wire 706a, a receive wire 706b, and a ground wire 706c. In the embodiment shown, the controller area network connection 706 is a bidirectional serial bus in which: the transmit wire 706a transmits control data from the various valve control units 302_{1-N} in the pump panel 604 to the valve interface units 304_{1-N} of the pump module 608; the receive wire 706b transmits status data from the valve interface units 304_{1-N} to the valve control units 302_{1-N}; and the ground wire 706c provides a reference voltage for use in determining the digital signal carried on one or both data wires 706a-b. In further embodiments, more or fewer wires can be used, and can be implemented using a differential signaling (e.g. twisted pair) configuration. Other wiring possibilities exist as well.

The controller area network connection 706 connects to each valve control unit 302 at a network interface 710, implemented in an integrated valve controller 712 that is a part of the valve control unit 302. The controller area network connection 706 also connects to each valve interface unit 304 at a network interface 714, implemented in an integrated valve interface 716 that is a part of the valve interface unit 304. The network interfaces 710, 714 send and receive data over the controller area network connection 706, and are implemented in hardware and/or software executing in the integrated valve controller 712 and integrated valve interface 716, respectively.

The network interfaces 710, 714 are each assigned addresses, allowing data broadcast from a single component to be detected at all other units configured to detect data on that interface. In the embodiment shown, because the transmit wire 706a and receive wire 706b are unidirectional, the various valve control units 302_{1-N} each transmit data on the transmit wire and “listen” for status information on the receive wire 706b. Conversely, the valve interface units 304_{1-N} “listen” for pump valve commands on the transmit wire 706a and return status information (e.g. pressure readings from gauges, etc.) via the receive wire 706b. Only that valve control unit or valve interface unit having the address included in the data packet takes action.

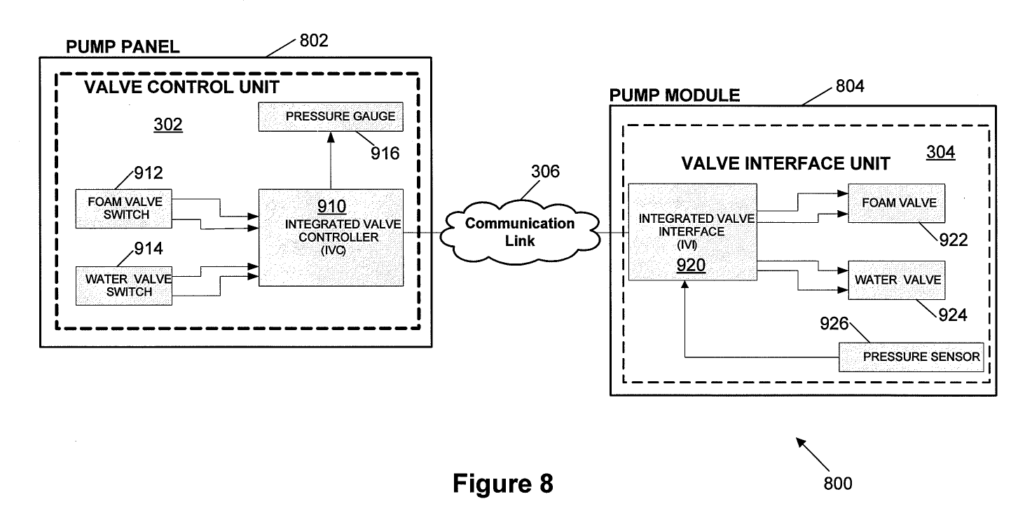

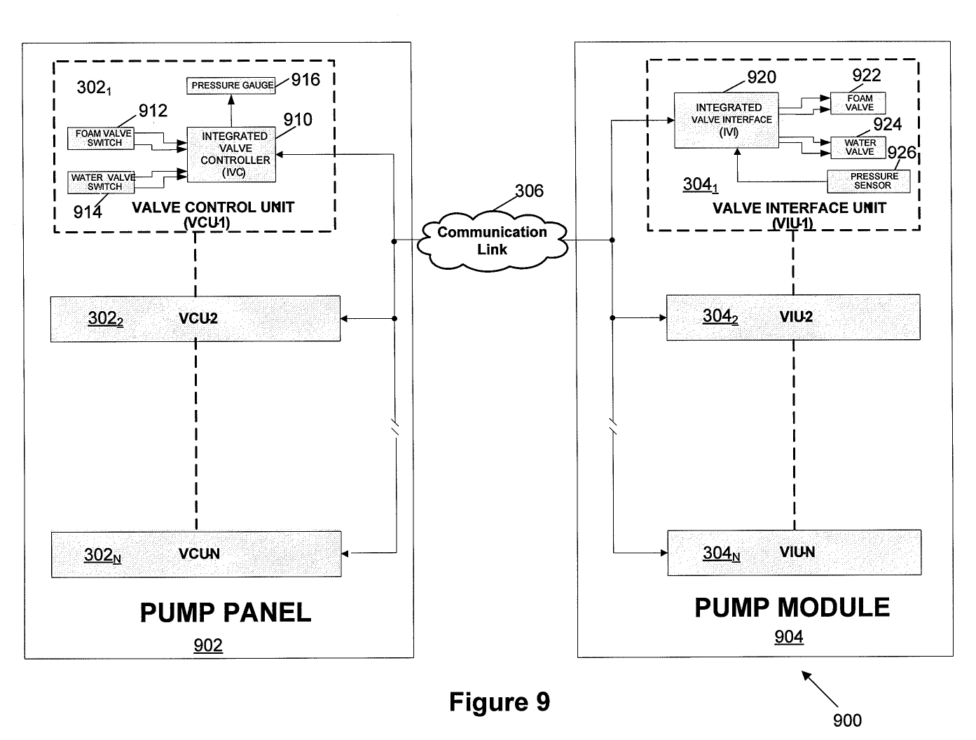

In the illustrated configuration of the controller area network connection 706, each valve control unit 302 can sense data from any of the valve interface units 304_{1-N}, but cannot receive information from the other valve control units. Each valve interface unit 304 can sense a pump valve command from any of the valve control units 302_{1-N} and can send status information to any of the valve control units, but cannot receive information from the other valve interface units 304. Other configurations of the network interface 710, 714 and the controller area network connection 706 are possible as well which would allow such communication. Additional explanation of certain example valve interface units and valve control units are shown in greater detail in FIGS. 8-9.

Now referring to FIGS. 8-9, example control systems are shown that are useable in the networks and systems of FIGS. 3-7. FIG. 8 illustrates a control system 800 using a single valve control unit 302 in a pump panel 802 and a single valve interface unit 304 in a pump module 804, while FIG. 9 illustrates a control system 900 of additional complexity, incorporating a plurality of valve control units 302_{1-N} in a pump panel 902 and a plurality of valve interface units 304_{1-N} in a pump module 904. The control systems 800, 900 illustrate incorporation of the valve control units and valve interface units into pump panels and pump modules while using a standard communication link 306 therebetween, whether it include a serial bus or wireless communication system, or both. Comparing FIGS. 8 and 9, it can be seen that the control systems can be extended without increasing the complexity or wire requirements of the communication link 306 between the pump panels 302 and pump modules 304, despite the system 900 having a large number of each.

In the systems 800, 900, each valve control unit 302 includes an integrated valve controller 910, interconnected with controls and a display. In the embodiment shown, the integrated valve controller is interfaced with a foam valve switch 912, a water valve switch 914 to control the valve, and a pressure gauge 916 is used as a display. However, other control switches or gauges can be included as well. Furthermore, other types of interfaces could be used, such as a touch screen interface, a keyboard and display, a pointing device, or other systems. The integrated valve controller senses inputs from the control switches 912, 914 and outputs signals to the display 916.

The integrated valve controller 910 also incorporates a network interface through use of software (e.g. as illustrated in FIG. 7). The network interface in the integrated valve controller 910 operates analogously to the network interface components 502, 508 of FIG. 5, assigning each valve control unit 302 a unique address within the systems 800, 900 and to generate data packets for transmission on the communication link. In certain embodiments, the data packets correspond to serial data packets, and are transmitted from the network interface according to a controller area network protocol.

In the system 800, 900, each valve interface unit 304 includes an integrated valve interface 920, which is communicatively connected to sensors and valves associated with a reservoir. In the embodiment shown, each valve interface 304 connects to a foam valve 922, a water valve 924, and a pressure sensor 926. Other valves and sensors can be included as well. The integrated valve interface 920 is configured to be able to actuate the valves 922, 924, and either periodically or continuously receive a signal from the pressure sensor 926 regarding the pressure experienced at the valve (e.g. for transmission back to the valve control unit 302). The integrated valve interface 920 also provides complementary data communications over the communication link 306, via a network interface analogous to the one incorporated into the integrated valve controller 910.

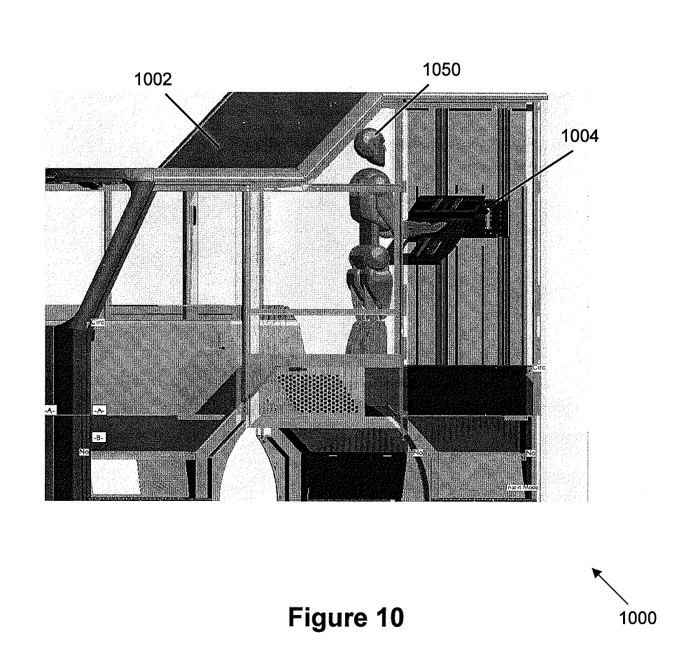

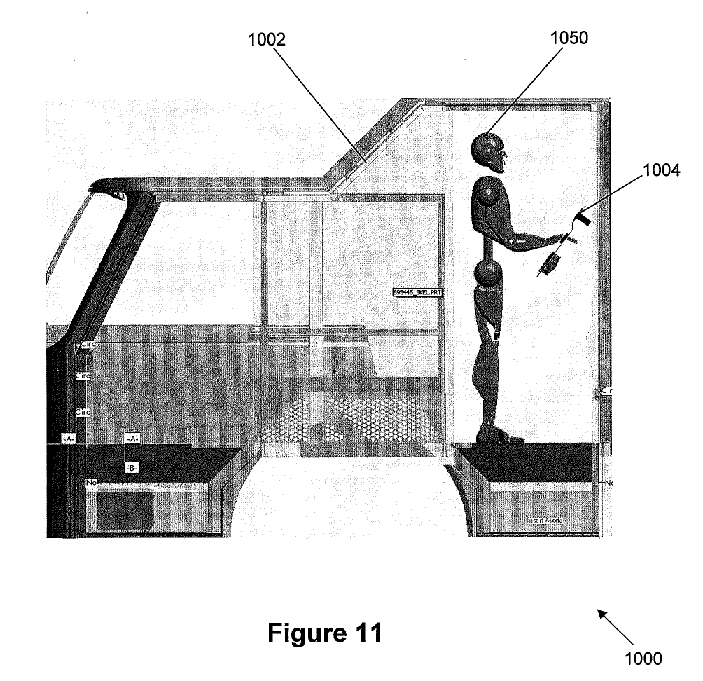

Now referring to FIGS. 10-11, a fire apparatus 1000 is shown. The fire apparatus includes a cab portion 1002, with a pump panel 1004 included therein. In the embodiment shown, the pump panel 1004 is in the interior of the cab portion 1002, and allows a user 1050 to control output of water and foam from the fire apparatus from within the cab portion 1002. As illustrated, the user 1050 is protected from external elements, such as heat, smoke, or inclement weather, while interacting with the control system via the pump panel 1004.

In the fire apparatus 1000 shown, although the pump panel 1004 resides within the cab portion 1002, a pump module (not shown) that includes valves resides at the rear of the fire apparatus 1000. The separation of the pump panel and pump module provides flexibility in design and interactions of fire apparatus 1000, and other pumping systems. Furthermore, although the pump panel 1004 is shown as residing within the cab portion 1002, it could be located at any other location on the fire apparatus 1000 convenient for user interaction, with minimal wiring complexity.

The above specification, examples and data provide a complete description of the manufacture and use of the composition of the invention. Since many embodiments of the invention can be made without departing from the spirit and scope of the invention, the invention resides in the claims hereinafter appended.

1. A control system for a self contained pumping system in a pumping vehicle, the system comprising:
a valve controller unit including an addressable communication module configured to exchange control and status data regarding a pump valve with at least one valve interface unit;
a valve interface unit including an addressable communication module configured to exchange control and status data regarding a pump valve with at least one valve controller unit; and
a serial communication link communicatively connecting the valve interface unit and the valve controller unit.

2. The control system of claim 1, wherein the serial communication link is a wired communication link.

3. The control system of claim 1, wherein the valve control unit is integral with a pump panel on the pumping vehicle.

4. The control system of claim 3, wherein the pump panel resides in a cab portion of the pumping vehicle.

5. The control system of claim 1, wherein the at least one valve interface unit is integral with a pump module on the pumping vehicle.

6. The control system of claim 1, wherein the serial communication link utilizes a controller area network communication protocol.

7. The control system of claim 1, wherein the at least one valve control unit includes an integrated valve controller.

8. The control system of claim 1, wherein the at least one valve control unit includes a plurality of valve switches.

9. The control system of claim 1, wherein the at least one valve control unit includes at least one pressure gauge.

10. The control system of claim 1, wherein the at least one valve interface unit includes an integrated valve interface.

11. The control system of claim 1, wherein the at least one valve interface unit includes at least one pressure sensor.

12. A method of communicating pump controls between a valve control unit and a valve interface unit, the method comprising:
transmitting a pump valve command over a serial link from a valve control unit; and
receiving the pump valve command at the valve interface unit.

13. The method of claim 12, further comprising receiving an input signal at a valve control unit, the input signal representing a pump valve command relating to a pump valve.

14. The method of claim 12, wherein the pump valve command is addressed to the valve interface unit associated with a pump valve.

15. The method of claim 14, further comprising actuating the pump valve.

16. The method of claim 12, wherein the valve control unit resides in a cab portion of a fire apparatus.

17. The method of claim 12, wherein transmitting the pump valve command over a serial link comprises transmitting the pump valve command over a controller area network.

18. A fire apparatus comprising:
a pumping system including a plurality of pump valves;
a control system for the pumping system, the control system including:
a valve controller including an addressable communication module configured to exchange control and status data regarding at least one of the plurality of pump valves with at least one valve interface;
a valve interface associated with at least one of the plurality of valves, the valve interface including an addressable communication module configured to exchange control and status data regarding the at least one pump valve with the valve controller; and
a serial communication link communicatively connecting the valve interface and the valve controller.

19. The fire apparatus of claim 18, wherein the serial communication link utilizes a controller area network protocol.

20. The fire apparatus of claim 18, wherein the serial communication link is a wired communication link.

21. The fire apparatus of claim 18, wherein the valve control unit is integral with a pump panel on the fire apparatus.

22. The fire apparatus of claim 21, wherein the pump panel resides in a cab portion of the fire apparatus.
